(19) United States
(12) Patent Application Publication
(10) Pub. No.: US 2006/0251905 A1
(43) Pub. Date: Nov. 9, 2006

(54) Gas barrier film and an organic device using the same

(75) Inventor: Jun Arakawa, Minami-ashigara-shi (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-ashigara-shi (JP)

(21) Appl. No.: 11/398,564

(22) Filed: Apr. 6, 2006

(30) Foreign Application Priority Data
Apr. 6, 2005 (JP) 2005-109356

(51) Int. Cl. B32B 17/06

(52) U.S. Cl. 428/429; 428/702

(57) ABSTRACT

A gas barrier film having a steam permeability at 38° C. and 90% relative humidity of 0.005 g/m²/day or less, which comprises an inorganic barrier layer containing two or more kinds of metal oxides and a polymer layer adjacent to the inorganic barrier layer on a plastic film substrate.

### BACKGROUND OF THE INVENTION

1. Field of the Invention

The present invention relates to a film having excellent gas barrier property and an flexible organic device, particularly, an organic electroluminescence device (hereinafter referred to as “organic EL device”) having greatly improved life and also excellent in the bending resistance by using the film.

2. Description of the Related Art

Gas barrier films in which thin films of metal oxide such as aluminum oxide, magnesium oxide, and silicon oxides are formed on the surfaces of plastic film substrate have been generally used so far for packaging of articles requiring shielding of steams or various gases such as oxygen, or packaging application for preventing denaturation of foodstuffs, industrial products, and medicines. Further, the gas barrier films have also been used in substrates of liquid crystal display devices, etc., solar cells or electroluminescence (EL) devices in addition to the packaging use. Particularly, in transparent substrates which have been applied progressively to liquid crystal display devices, EL devices, etc., high level of demands such as long time reliability, high degree of freedom in view of shape, and capability of display on a curved surface have been required in addition to the demand for reduction in the weight and increase in the size. Film substrates such as made of transparent plastics have been started for use instead of glass substrates, which are heavy, tended to be cracked and difficult in increasing the area. Further, since the plastic films not only can cope with the requirements described above but also can be applied to the roll-to-roll system, they are advantageous over glass materials in view of the productivity and the reduction of cost.

However, film substrates such as of transparent plastics involve a problem of poor gas barrier property in comparison with glass. In a case of using a substrate of poor gas barrier property to deteriorate, for example, liquid crystals in a liquid crystal cell, which results in display defects to deteriorate the display quality. For solving such problems, it has been known to form a thin film of a metal oxide on the film substrate as a gas barrier film substrate. As gas barrier films used for packaging materials and liquid crystal display devices, those formed by vacuum depositing silicon oxide on a plastic film (refer to JP-B No. 53-12953 (p1 to p3) (Patent Document 1) and those formed by vapor depositing aluminum oxide (refer to JP-A No. 58-217344 (p1 to p4) (Patent Document 2)) are known and each of them has a steam barrier property of about 1 g/m²/day. The steam barrier property as low as about 0.1 g/m²/day has been demanded recently for the film substrate along with increase in the size of liquid crystal displays or development for highly fine displays.

In recent years, demand for light weight and flexible wearable devices have been increased remarkable intending for the ubiquitous society and development has been progressed in organic semiconductors, organic EL displays, organic solar cells, etc. mainly comprising organic materials. However, it has been found that any of such organic devices is degraded remarkably under the effects of steams or oxygen and the demand for the barrier property has been required further for plastic films as the substrate materials.

Most recently, development has been progressed for the organic EL displays requiring further barrier property, and basic materials having the function of higher barrier property, particularly, a steam barrier property of less than 0.005 g/m²/day while maintaining transparency usable therefor has been required. In conforming the demand, as means capable of expecting higher barrier performance, film formation by a sputtering method or a CVD method of forming thin films by using plasmas generated by grow discharge under the conditions of a low pressure has been studied.

Further, a technique of manufacturing a barrier film having an alternative laminate structure of polymer layer/inorganic layer by a vacuum vapor deposition method has been proposed (refer to U.S. Pat. No. 6,268,695, p4 [2-5] to p5 [4-49]) or JP-A No. 2003-53881, p3 [0006] to p4 [0008]). The barrier films have a structure formed by disposing a gas barrier film as a lamination of polymer layer/inorganic layer on a transparent resin layer, disposing an organic EL structure containing a light-emitting layer thereon and laminating a polymer layer/inorganic layer further thereon to provide a barrier property.

In general barrier films, film formation of the inorganic layer is conducted, for example, by a sputtering method, a vacuum vapor deposition method, an ion plating method, or a plasma CVD method (refer to JP No. 3400324, JP-A Nos. 2002-322561 and 2002-361774). While oxides, nitrides, or oxynitrides such as of Si, Al, In, Sn, Zn, Ti, Cu, Ce, and Ta are used, aluminum oxide and silicon oxide are often used as the inorganic layer for making high barrier property and high permeability compatible with each other.

Also the inorganic layer described in U.S. Pat. No. 6,268,695 and JP-A No. 2003-53881 are formed of silicon oxide or aluminum oxide by using an electron beam vapor deposition method or a sputtering method individually. However, while they are considerably satisfactory in view of the performance as the gas barrier property by the method, they are not yet insufficient for the barrier property required for the organic devices such as organic EL and improvement has been demanded. Further, it has also been found that the barrier films manufactured by the methods described above are deteriorated in view of the barrier property remarkably upon applying the operation of repetitive bending.

Further, as shown in JP-A No. 6-23901 (p1 to p4), there is disclosed a gas barrier packaging material mainly for use in retort in which a transparent thin film comprising silicon oxide and an aluminum oxide is formed on a transparent plastic film. However, this is an inorganic mono-layer film and attains only the low barrier property necessary for use in foodstuffs (steam permeability of 0.2 g/m²/day or more). Further, the resistance to repetitive bending is also insufficient and it is extremely poor for the use in the gas barrier film required for the flexible organic device.

### SUMMARY OF THE INVENTION

The present invention has been accomplished in view of the foregoings and an object of the invention is to provide an organic device such as an organic EL device capable of attaining a long life by maintaining excellent gas barrier property even when it is bent. Another object of the invention is to provide a gas barrier film used effectively for the manufacture of such an organic device.

In accordance with the present invention, there are provided:
(1) A gas barrier film comprising, on a plastic film substrate, at least one two-layer unit consisting of an inorganic barrier layer and a polymer layer adjacent to the inorganic barrier layer, in which at least one of the inorganic barrier layers in the gas barrier film comprises two or more kinds of metal oxides, and the steam permeability of the gas barrier film at 38° C. and 90% relative humidity is 0.005 g/m²/day or less.
(2) a gas barrier film according to (1) described above, comprising at least one gas barrier lamination member in which a two-layer unit consisting of an inorganic barrier layer comprising two or more kinds of metal oxides and a polymer layer adjacent to the inorganic barrier layer is laminated repetitively by 3 to 5 times,
(3) a gas barrier film according (1) or (2) above wherein the two or more kinds of metal oxides contain aluminum oxide and silicon oxide,
(4) a gas barrier film according to any one of (1) to (3) above, wherein the inorganic barrier layer comprising two or more kinds of metal oxides is formed by a reactive sputtering method with plasma in which a plurality of metal targets and an oxygen gas are used as starting materials,
(5) a gas barrier film according to any one of (1) to (3) above, wherein the inorganic barrier layer comprising two or more kinds of metal oxides is formed by a vapor deposition method under electron beam heating in which a plurality of metals or metal oxides are used as an evaporation source,
(6) a gas barrier film according to any one of (1) to (5) above, wherein the polymer constituting the plastic film substrate has a glass transition temperature of 120° C. or higher and a light transmittance in the entire wavelength region of from 400 nm to 700 nm of 85% or higher,
(7) a gas barrier film according to any one of (1) to (6) above, wherein the polymer layer contains a polysiloxane formed by a plasma polymerization method,
(8) a gas barrier film according to any one of (1) to (6) above, wherein the polymer layer contains a polyparaxylylene formed by a vapor deposition polymerization method,
(9) a gas barrier film according to any one of (1) to (6) above, wherein the polymer layer contains a polymer formed by a polyaddition reaction in which two kinds of monomers are evaporated in vacuum,
(10) a gas barrier film according to any one of (1) to (6) above, wherein the polymer layer is formed by forming a thin film of an acrylic polymer by a flash vapor deposition method and then curing the same by using UV-rays or electron beams.
(11) a gas barrier film according to any one of (1) to (6) above, wherein the polymer layer is formed by forming a thin film of a photocationic curable polymer by a flash vapor deposition method and then curing the same by using UV-rays or electron beams,
(12) an organic device manufactured by using a gas barrier film according to any one of (1) to (11) above.

The gas barrier film of the invention has an extremely high gas barrier property. Further, the organic device, particularly, the organic EL device of the invention manufactured by using the gas barrier film is flexible and has long life.

### BEST MODE FOR CARRYING OUT THE INVENTION

The gas barrier film according to the present invention is to be described specifically. Explanation for the constituent factors to be described later are sometimes based on typical embodiments of the invention but the invention is not restricted to such embodiments. In the specification, ranges for numeral values represented by “---- to ---” means ranges including numeral values described before and after “to” as the lower limit value and the upper limit value.

Gas Barrier Film

(1) Laminate Barrier Unit

The gas barrier film of the invention has at least one laminate barrier unit having at least one inorganic barrier layer and at least one polymer layer on a plastic film substrate.

Then, each of constituent members of the laminate barrier unit is to be described.

Inorganic Barrier Film

At least one of the inorganic barrier layers constituting the laminate barrier unit comprises two or more of metal oxides. The inorganic barrier layer can be formed by depositing two or more kinds of metal oxides simultaneously on a film.

The metal oxides include oxides, for example, of Si, Al, In, Sn, Zn, Ti, Cu, Ce, and Ta, with no restriction to them. In view of the cost and the light transmittance upon forming the film, silicon oxide and aluminum oxide are preferred.

As a method of forming the oxide thin films, known methods such as sputtering method, a vacuum vapor deposition method, an ion plating method, a plasma CVD method, etc. can be used, and the reactive sputtering method, the electron beam heating vapor deposition method and the method of combining them are particularly preferred in view of depositing two kinds of oxides simultaneously while controlling the ratio thereof.

The reactive sputtering method is a method of disposing, for example, metal targets of Si and Al respectively on two electrodes and driving out metal atoms by DC plasmas or RF plasmas while introducing a rare gas such as argon and an oxygen gas in high vacuum and codepositing them while reacting the metal atoms and oxygen on the surface of a film.

Further, the electron beam heating vapor deposition method is a method of disposing a crucible that contains Si or SiOₓ and a crucible that contains Al or AlOₓ into a vacuum chamber, heating to evaporize them respectively by electron beams and co-depositing them on the film surface. In this case, the oxygen gas may or may not be supplied depending on the oxidation degree of the material contained in the crucible and the oxidation degree of the aimed film.

While the ratio between the two kinds of metals co-deposited in the oxide thin film can be set optionally, it is, preferably, within a range from 1/9 to 9/1. In a case of silicon oxide and aluminum oxide, the Si/Al ratio is, preferably, within a range from 7/3 to 2/8.

Further, while the ratio between each of the metal atoms and the oxygen atoms is also optional, in a case where the ratio of the oxygen atoms is extremely less than the stiochiometrical ratio of the oxides, this is not preferred since the transparency of the film is lowered, or pigmentatin occurs. On the other hand, in a case where the ratio of the oxygen atoms is excessive it is not preferred since the density of the film is lowered to deteriorate the barrier property. In a case of SiOₓ, the value x is, particularly preferably, from 1.5 to 1.8. In a case of AlOₓ, the value x is, particularly preferably, from 1.0 to 1.4.

In a case where the thickness of the inorganic barrier layer is excessively thin, the barrier property becomes insufficient and, on the other hand, if it is excessively thick, this results in crackings or breakage to remarkably deteriorate the barrier property. Then, an appropriate thickness of the inorganic barrier layer is within a range, preferably, from 5 nm to 1000 nm, more preferably, from 10 nm to 1000 nm and, most preferably, from 10 nm to 200 nm.

Polymer Layer

For the polymer layer constitution the laminate barrier unit, any of polymers can be used and preferred are those that can be formed into films in a vacuum chamber. Examples of preferred polymer layers and film formation method therefor are to be described below.

1) Polysiloxane

Vapors formed by heating to evaporate hexamethyl disiloxane are introduced to a parallel plate type plasma apparatus by using an RF electrode, polymerizing reaction is taken place in the plasma, and polysiloxane is deposited as a thin film on a film substrate. This is particularly preferred having advantageous features that the film forming speed is high, no polymerization initiator is necessary, intimate contact with the inorganic barrier layer to be deposited subsequently is favorable since it can be made hydrophilic easily by oxygen plasmas, etc. and the bending resistance is excellent when a laminate barrier film is formed.

2) Polyparaxylilene

Polyparaxylilene is evaporated by heating in high vacuum and the vapors are thermally decomposed by heating at 650° C. to 700° C. to generate thermal radicals. When the vapors of the radical monomers are introduced into the chamber, the radical polymerization reaction proceeds at the same time with adsorption to the film substrate and they are deposited as polyparaxylilene. The film has a feature in that a film excellent in the mechanical, thermal and chemical strength is formed and the method is also preferred for the invention.

3) Polyaddition Polymer

This is a polymer formed from two kinds of monomers A and B evaporated in vacuum by repetitive addition polymerization of A and B alternately. For example, low molecular weight materials such as water or alcohol are not dissociated, for example, as in the case of polycondensation and this is basically excellent as a method of forming a barrier film in vacuum.

The polyaddition polymer includes polyurethane(diisocyanate/glycol), polyurea(diisocyuanate/diamine), polythiourea(dithioisocyanate/diamine), polythioetherurethane(bisethylene urethane/dithiol), polyimine(bisepoxy/primary amine), polypeptide amide(bisazolacton/diamine), and polyamide(diolefin/diamide), and polyurea is particularly preferred in view of the transparency, the material cost, etc.

4) Acrylate Polymer

Since the acrylic polymer has a feature in that the curing rate is high, curing is easy at a room temperature and the transparency is high, it is used preferably as the polymer layer in the invention.

The acrylate monomer includes mono-functional, di-functional, and poly-functional monomers and any of them can be used. Among all, it is preferred to blend them for obtaining appropriate evaporation rate, curing degree, curing rate, etc. The mono-functional acrylate includes those containing aliphatic group, cycloaliphatic group, etheric group, cycloetheric group, aromatic group, hydroxyl group and carboxyl group, and any of them can be used.

5) Photocation-Curable Polymer

The cation polymerization system has a feature in that it is less stimulative compared with a photo-curable acrylate. Particularly, since ring-opening polymerization type such as epoxy or oxethane type has less internal stress and is excellent in adhesion due to small volumic shrinkage during curing, it is particularly preferred in the invention.

As the epoxy type, a cycloaliphatic epoxy type is particularly preferred, and difunctional monomers, multi-functional oligomers, and mixtures thereof can be used preferably.

As the oxethane type, mono-functional oxethane, difunctional oxethane, oxethanes having a silsesqui-oxanes structure, etc. are preferred and, mixtures thereof, mixtures with further addition of glycidyl ether compounds and, further, mixtures with epoxy compounds are also preferred.

In the case of the photo-cation-curable polymer, a photo-curing latent curing agent that starts light-triggered curing reaction may also be contained. For the epoxy type or oxethane type polymer, a photo-acid generator is usually preferred. As the photo-acid generator, aryldiazonium salts, diaryliodonium salts, etc. are known with the triarylsulfonium salts being most general.

Further, use of a compound forming photo-radicals in combination as the sensitizer is preferred. As the sensitizer, aromatic ketones, phenothiazines, diphenyl anthracene, rubrene, xantone, thixantone derivatives, chlorothioxantone, etc. are used, with the thioxantone derivatives being preferred.

In a case of using the gas barrier film of the invention for an organic device such as an organic EL device, reaction residues of the monomer used for forming the polymer layer, reaction by-products, polymerization initiator, additives such as a sensitizer, UV-light, electron beams, heating, etc. used for the curing reaction often gives undesired effects on the performance of the device (particularly, the life thereof). Accordingly, while it is important to remove such undesired effects, it has been considered to be difficult to thoroughly eliminats the effects caused by the factors described above in the means for forming the polymer film in vacuum among the means for forming the polymer layer described above.

Further, quantitative analysis for the effects of the factors on the performance and the storability of the organic device has not been conducted so far, which remains still unknown.

The present inventors have made a detailed study for the effects on the organic EL device in view of each of the means for forming the polymer film described above. As a result, it has been found that the polyaddition reaction method (3) gives least effects on the performance and the life of the organic EL device and this is an extremely excellent method.

While the thickness of the polymer layer is not particularly restricted, it is, preferably, from 10 nm to 5000 nm, more preferably, from 10 to 2000 nm and, most preferably, from 10 nm to 5000 nm. In a case where the polymer layer is excessively thin, since it is difficult to obtain a uniform thickness, structural defects of the inorganic barrier layer can not be covered efficiently by the polymer layer, failing to improve the barrier property. On the other hand, in a case where the polymer layer is excessively thick, since cracks tend to be generated in the polymer layer per se due to external force such as bending, this results in a disadvantage of deteriorating the barrier property.

The method for forming the polymer layer of the invention includes a coating method, a vacuum film forming method, etc., with the vacuum film forming method being preferred. While there is no particular restriction for the vacuum film forming method, a film forming method such as vapor deposition or plasma CVD is preferred, and an ohmic heating vapor deposition method capable of easily controlling the film forming rate of the organic material monomer is more preferred. While crosslinking method of the organic material monomer of the invention is not restricted, electron beams or UV-light crosslinking by irradiation of active energy rays is preferred in view of easy attachment to the inside of a vacuum vessel or rapid increase in the high molecular weight by the crosslinking reaction.

In a case of preparation by the coating method, various coating methods used so far, for example, roll coating, gravure coating, knife coating, dip coating, curtain flow coating, spray coating, bar coating, etc. can be used.

Further, in the invention, the polymer layer may also contain ingredients other than the organic ingredient, that is, inorganic materials, inorganic elements, and metal elements. An organic/inorganic hybrid material may be used by hydrolysis of metal alkoxide and polycondensating reaction in combination. As the metal alkoxide, alkoxy silanes and/or metal alkoxides other than the alkoxy silanes are used. The metal alkoxides other than the alkoxy silanes are preferably zirconium alkoxide, titanium alkoxide, aluminum alkoxide, etc. Further, known inorganic fillers such as fine inorganic particles or layered silicate salts can be mixed optionally to the polymer layer.

The active energy rays for forming the polymer in the invention mean radiation rays capable of transmitting energy by irradiation, for example, of UV-rays, X-rays, electron beams, infrared rays, and microwaves, and the kind and the energy thereof can be optionally selected in accordance with the application use.

Polymerization of the monomers in the invention is started after coating or vapor depositing a monomer-containing composition, by contact heating with a heater or the like, radiation heating with infrared rays or microwaves in a case of using the heat polymerization initiator. The polymerization is started by irradiation of active energy rays in a case of using the photopolymerization initiator. In a case of irradiating UV-rays, various light sources can be used and, for example, curing can be conducted by irradiation light of a mercury arc lamp, a xenon arc lamp, a fluorescence lamp, a carbon arc lamp, a tungsten-halogen radiation lamp, and sun-light. The irradiation intensity of the UV-light is at least 0.01 J/cm². In a case of conducting curing continuously, it is preferred to set the irradiation rate such that the composition can be cured within 1 to 20 sec. In a case of curing by using electron beams, curing is conducted by electron beams at an energy of 300 eV or less and it is also possible to cure instantaneously at an irradiation amount of from 1 Mrad to 5 Mrad.

The lamination unit of at least one set of inorganic barrier layer/polymer layer may be disposed either on one surface or on both surfaces of a plastic film substrate. Further, in adjacent with the lamination unit described above, one or more sets of the lamination units of the inorganic barrier layer/polymer layer may be further laminated repetitively. In a case of repetitive lamination, the number of repetitive lamination units is preferably 5 units or less with a view point of the gas barrier property and the production efficiency. In a case of repetitive lamination, the inorganic barrier layer and the polymer layer for constituting each of the lamination units may comprise an identical composition or different compositions respectively.

(2) Plastic Film Substrate

The plastic film substrate used for the gas barrier film of the invention is not particularly restricted so long as the film can maintain each of the layers and can be selected properly depending on the purpose of use of the gas barrier film or the like. Specifically, the material for the substrate includes thermo-plastic resins such as polyester resin, methacryl resin, methacrylic acid-maleic acid copolymer, polystyrene, transparent fluoro resin, polyimide resin, fluorinated polyimide resin, polyamide resin, polyamide imide resin, polyether imide resin, cellulose acylate resin, polyurethane resin, polyether ether ketone resin, polyarbonate resin, cycloaliphatic polyolefin resin, polyallylate resin, polyether sulfone resin, polysulfone resin, cycloolefin copolymer, fluorene ring modified polycarbonate resin, cycloaliphataic modified polycarbonate resin, and acryloyl compound.

Among the resins, preferred examples include polyester resin, polyarylene resin (PAr), polyether sulfone resin (PES), fluorene ring modified polycarbonate resin (BCF-PC: compound in Example 4 of JP-A No. 2000-227603), cycloaliphatic modified polycarbonate resin (IP-PC: compound in Example 5 of JP-A No. 2000-227603), and acryloyl compound (compound in Example 1 of JP-A No. 2002-80616). Further, condensed polymers including spirobiindane and spirobichroman may also be used preferably.

Among the polyester resins, polyethylene terephthalate (PET) applied with biaxial stretching, and polyethylene naphthalate (PEN) also applied with biaxial stretching are used preferably as the plastic film substrate in the invention since they are excellent in the thermal dimensional stability.

The structural unit of the resin used as the plastic film substrate in the invention may consist only of one kind, or two or more of the units may be in admixture. Further, other structural unit may also be incorporated within a range not impairing the effect of the invention. While the substitution amount is usually 50 mol % or less, it is, preferably, 10 mol % or less. The resin used as the plastic film substrate in the invention may also be blended with other resin, and it may comprise two or more kinds of resins.

The molecular weight of the resin used as the plastic film substrate in the invention is, preferably, from 10,000 to 300,000 (being converted as polystyrene) used as the plastic film substrate in the invention and, more preferably, from 20,000 to 200,000 and, most preferably, from 30,000 to 150,000. In a case where the molecular weight is low, mechanical strength of the gas barrier film is insufficient when it is used as the plastic substrate.

For the plastic film substrate, crosslinked resins are also used preferably with a view point of solvent resistance, heat resistance, etc. As the kind of the crosslinked resin, various known resins including both thermosetting resins and radiation-curable resins can be used with no particular restriction. Examples of the thermosetting resin include, phenol resin, urea resin, melamine resin, unsaturated polyester resin, epoxy resin, silicone resin, diallylphthalate resin, furan resin, bismaleimide resin, cyanate resin, etc. In addition, any crosslinking method can be used with no particular restriction so long as this adopts a reaction of forming covalent bonds. A system proceeding the reaction at a room temperature by using a polyalcohol compound and a polyisocyanate compound to form urethane bonds can also be used with no particular restriction.

Radiation-curable resin is generally classified into radical-curable resin and cation-curable resin. As the curing ingredient of the radical curable resin, compounds having a plurality of radical polymerizable groups in the molecule are used and, as typical examples, a compound referred to as a poly-functional acrylate monomer having acrylate ester groups by the number of 2 to 6 in the molecule, and compounds having a plurality of acrylate ester groups in the molecule referred to as urethane acrylate, polyester acrylate or epoxy acrylate are used as the typical example. The typical curing method for radical-curable resin includes a method of irradiating electron beams and a method of irradiating UV-rays. Usually, in the method of radiating the UV-rays, a polymerization initiator that generates radicals by the irradiation of UV-rays is added. In a case of adding the polymerization initiator that generates radicals by heating, the resin can be used as the thermosetting resin. As the curing ingredient of the cation-curable resin, a compound having a plurality of cation polymerizable group in the molecule is used and a typical curing method includes a method of adding a photo-acid generator that generates an acid by the irradiation of UV-rays and irradiating UV-rays to conduct curing. Examples of the cation-polymerizable compound include, compounds containing a ring-opening polymerizable groups such as epoxy groups or compounds containing vinyl ether groups.

For the plastic film substrate, lamination, blend, etc. of different kinds of resins can be used suitably with an aim of controlling the retardation (Re) or improving the gas barrier property and dynamic characteristics.

A preferred combination of different kinds of resins is not particularly restricted and any of the resins described above can also be used.

Further, with an aim of greatly changing the retardation, it is also preferred to use organic low molecular weight compounds as disclosed in JP-A No. 7-92904 or block copolymerizing monomers of different optical anisotropy as disclosed in the pamphlet of WO 98/04601.

Further, it is also a preferred method of optically adding isotropic fine inorganic particles having orientation property as described in JP-A No. 11-293116.

The resin used in the invention not being restricted only to the polyester resin, may be stretched. Stretching can provide advantages of improving the mechanical strength such as flexion resistance and improvement of handlability. Particularly those having an orientation release stress (ASTM D1504, hereinafter simply referred to as ORS) in the stretching direction of from 0.3 to 3 GPa are preferred since the mechanical strength is improved. ORS is an internal stress caused by stretching which is frozen in a stretched film or sheet.

Known method can be used for the stretching and the resin can be stretched by a monoaxial roll stretching method, a monoaxial tenter stretching method, simultaneous biaxial stretching method, a sequential biaxial stretching method, or an inflation method at a temperature higher by 10° C. to 50° C. than the glass transition temperature (Tg) of the resin. From 1.1 to 3.5 times of stretching factor is used preferably.

The thickness of the plastic film substrate used in the invention is not particularly restricted and it is, preferably, from 30 μm to 700 μm, more preferably, 40 μm to 200 μm and, further preferably, from 50 μm to 150 μm. Further, in any of the cases, haze, is preferably, 3% or less, more preferably, 2% or less and, further preferably, 1% or less. The total light transmittance is, preferably, 70% or more, more preferably, 80% or more and, further preferably, 90% or more.

In the plastic film substrate used in the invention, resin modifiers such as plasticizer, dye and pigment, antistatic agent, UV-absorbent, anti-oxidant, fine inorganic particles, peeling promotor, leveling agent, inorganic layerd silicate salt compound, and lubricant may also be added optionally within a range not deteriorating the effect of the invention.

(3) Functional Layer

In the gas barrier film of the invention, various kinds of functional layers such as a transparent conductive layer or a primer lay may also be disposed in addition to the lamination barrier unit. Description is to be made for various kinds of the functional layers.

Transparent Conductive Layer

For the transparent conductive layer of the invention, known metal films and metal oxide films are applicable and, among all, metal oxide films are preferred with a view point of transparency, conductivity, and mechanical characteristics. For example, they include films of metal oxide such as indium oxide, cadmium oxide, and tin oxide with addition of tin, tellurium, cadmium, molybdenum, tungsten, and fluorine as the impurities, and zinc oxide and titanium oxide with addition of aluminum as the impurity. Among them, a thin film of indium oxide (ITO) containing from 2 to 15 mass % of tin oxide is excellent in view of transparency and conductivity which is used preferably. The method of forming the transparent conductive layer include, for example, a vacuum vapor deposition method, a sputtering method, an ion beam sputtering method, etc.

While the thickness of the transparent conductive layer is preferably from 15 to 300 nm. In a case where it is less than 15 nm, a film becomes in continuous making the conductivity insufficient. On the other hand, if it exceeds 300 nm, transparency is lowered or flexion resistance is worsened.

The transparent conductive layer may be disposed either on the side of the substrate or on the side of the gas barrier coat layer so long as it is situated to the outermost layer, it is preferably disposed on the side of the gas barrier coat layer for preventing intrusion of micro amount of water contained in the plastic film substrate.

Primer Layer

In the gas barrier film of the invention, a known primer layer or an inorganic thin film layer may be disposed between the plastic film substrate and the lamination barrier unit. As the primer layer, acryl resin, epoxy resin, urethane resin, silicone resin, etc. can be used. In the invention, an organic/inorganic hybrid layer is preferred as the primer layer. As the inorganic thin film layer, an inorganic vapor deposition layer or a dense inorganic coating thin film by a sol-gel method is preferred. As the inorganic vapor deposition layer, a vapor deposition layer such as of silica, zirconia, or alumina is preferred. The inorganic vapor deposition layer can be formed, for example, by a vacuum vapor deposition method or a sputtering method.

Other Functional Layers

Various known functional layers may be disposed optionally above the lamination barrier unit or to the outermost layer respectively. Examples of the functional layer include an optical functional layers such as anti-reflection layer, polarization layer, color filter, UV-absorbent layer, and light take-out efficiency improving layer, dynamic functional layers such as hard coat layer and stress relaxation layer, electrical functional layers such as antistatic layer and conductive layer, anti-clouding layer, anti-contamination layer and a printed layer.

(4) Property of Gas Barrier Film

The steam permeability of the thus obtained gas barrier film of the invention is, preferably, 0.005 g/m²/day or less, preferably, 1×10⁻⁴ g/m²/day or less and, particularly preferably, 1×10⁻⁵ g/m²/day. Also the oxygen permeability is 0.005 cm³/m²/day/atm or less and, particularly preferably, 1×10⁻⁴ cm³/m²/day/atm or less.

In a case of use for the manufacture of a flexible and transparent organic EL device, the light permeability of the gas barrier film is an important performance. The value of the light transmittance is, preferably, 80% or more and, particularly preferably, 85% or more at a wavelength of 550 nm.

For the flexibility, it is necessary that the surface suffers from no change such as cracks even when bent at a curvature of 100 mm for 1 day and, more preferably, it should be durable also for the curvature of 10 mm.

Further, in order to dispose a TFT circuit, a gas barrier film as substrate requires a heat resistance at high temperature. It is necessary that the film suffers from no deformation up to 250° C. at the lowest and, further preferably, it is durable for use up to 350° C.

In order that the organic EL structure does not peel by the temperature change or causes no gap at the boundary with adhesives, the heat expansion coefficient of gas barrier film is, preferably, 100 ppm or less, more preferably, 50 ppm or less and, particularly, 20 ppm or less.

Organic Device

The organic devise in the invention includes, for example, image display device (organic EL device, liquid crystal display device, electronic paper, etc.) dye-sensitization solar cell, touch panel, etc. While the use of the gas barrier film according to the invention is not particularly restricted, it can be used suitably as a substrate or a sealing film of the organic device. Description is to be made specifically for an organic EL device as a preferred organic device (hereinafter sometimes referred to simply as “light emitting device). The organic EL device has a cathode and an anode above a substrate and has an organic compound layer containing an organic light emitting layer (hereinafter sometime referred to simply as “light emitting layer”) between both of the electrodes.

Anode

For the anode, it may usually suffice that it has a function as an anode for supplying holes to an organic compound layer and there are no particular restriction for the shape, structure and size and can be selected properly from known electrodes depending on the application use and the purpose of the light emitting device.

The material for the anode includes preferably, for example, metals, alloys, metal oxides, organic conductive compounds or mixtures thereof and those having a work function of 4.0 eV or higher are preferred. Specific examples include semiconductive metal oxides, such as tin oxides doped with antimony, fluorine, etc. (ATO, FTO), tin oxide, zinc oxide, indium oxide, indium tin oxide (ITO), zinc indium oxide (IZO), metals such as gold, silver, chromium, and nickel, as well as mixtures or laminates of such metals with conductive metal oxides, copper iodide and cupper sulfide, dispersions of the semiconductive metal oxides or metal compounds, organic conductive materials such as polyaniline, polythiophene, and polypyrrol, and laminates thereof with ITO.

The anode can be formed above a substrate by a method selected properly, for example, from wet methods such as printing method or coating method, physical methods such as a vacuum vapor deposition method, sputtering method, or ion plating method, and chemical methods such as CVD, plasma CVD, etc. while considering the adaptability with the materials. For example, in a case of selecting ITO as a material for the anode, the anode can be formed in accordance with DC or RF sputtering method, vacuum vapor deposition method, ion plating method, etc. In case of selecting the organic conductive compound as the material for the anode, it can be formed in accordance with the wet film forming method. Particularly, in the invention, use of the wet film forming method is preferred in view of the increase in the area of the light emitting device and the productivity thereof.

Patterning for the anode layer may be conducted by a chemical etching method such as photoliphography or a physical etching method by a laser or the like, or it may be formed by applying vacuum vapor deposition or sputtering while stacking a mask or may be formed by a lift off method or printing method.

The thickness for the anode layer can be selected properly depending on the material and while it can not be defined generally, it is usually from 10 nm to 50 μm and preferably, from 50 nm to 20 μm.

The resistance value of the anode is, preferably, 10⁶ Ω/□ or less and, more preferably, 10⁵ Ω/□ or less. In a case where it is less than 10⁵ Ω/□ or less, a large area light-emitting device of excellent performance can be obtained by disposing a bass line electrode of the invention.

The anode may be colorless transparent, colored transparent or not transparent.

Transparent Cathode

As the cathode, it may suffice to have a function as a cathode for injecting electrons into the organic compound layer, and it is substantially transparent to the light with no particular restriction on the shape, structure, size, etc. thereof, which may be properly selected from known electrodes depending on the application use and the purpose of the light-emitting device.

The constitution of the cathode may be a single-layered structure, or may adopt a 2-layered structure comprising a thin film metal layer and a transparent conductive layer in order to make the electron injecting property and the transparency compatible. The metal material used for the metal layer of the thin film includes, for example, metal elements, alloys, etc. and those with a work function of 4.5 eV or less is preferred. Specific examples include alkali metals (for example, Li, Na, K, Cs, etc.) group II metal alkaline earth metals (for example, Mg, Ca, etc.), gold, silver, lead, aluminum, sodium-potassium alloy, lithium-aluminum alloy, magnesium-silver alloy, indium, and rare earth metals such as ytterbium. They may be used each alone, or to or more of them may be used preferably in combination with a view point of making the stability and the electron injection property compatible.

Among them, alkali metals or group II alkaline earth metals are preferred in view of the electron injecting property and materials mainly comprising aluminum are preferred in that they are excellent in store stability.

The materials mainly comprising aluminum include aluminum alone, or alloys or mixtures of aluminum and 0.01 to 10 mass % of alkali metals or group II metal alkaline earth metals (for example, lithium-aluminum alloy, magnesium-aluminum alloy), etc.

The materials for the thin film metal layer are specifically described in JP-A No. Hei 2-15595 and Hei 5-121172. The thickness of the metal layer of the thin film is preferably from 1 nm to 50 nm. In a case where it is less than 1 nm, it is difficult to uniformly form a film of the thin film layer. Further, in case where it is more than 50 nm, light transparency is worsened.

The materials used for the transparent conductive layer in a case of adopting the 2-layered structure, have no particular restriction so long as the materials are conductive or semiconductive and transparent. The materials described for the anode above are used suitably and, among all, they include, for example, tin oxide doped with antimony or fluorine (ATO, FTO), tin oxide, zinc oxide, indium oxide, indium tin oxide (ITO), zinc oxide indium (IZO), etc.

The thickness of the transparent conductive layer is, preferably, from 30 nm to 500 nm. The conductivity and the semiconductivity are worsened in a case where it is less than the range described above, while the productivity is worsened in a case where it exceeds the range described above.

The method of forming the cathode is not particularly restricted and can be conducted in accordance with known method and in the vacuum facility. In this invention, for example, the cathode can be formed above the substrate in accordance with a method selected properly from physical method such as vacuum vapor deposition, sputtering method, ion plating method, etc. chemical method such as CVD or plasma CVD while considering the adaptability with the materials described above. For example, in a case of selecting the metal as the material for the cathode, it can be conducted by forming one or two or more of them simultaneously or successively in accordance with a sputtering method or the like.

The cathode may be patterned by chemical etching using photolithography or the like, or physical etching by laser, or the like. Further, the cathode may be patterned also by vacuum vapor deposition or sputtering by stacking a mask or by a lift off method or printing method.

Further, a dielectric layer comprising the fluoride of the alkali metal or the group II metal alkaline earth metal by a thickness of 0.1 to 5 nm between the cathode and the organic compound layer.

Further, the dielectric layer can be formed, for example, by vacuum vapor deposition, sputtering, ion plating or the like.

Organic Compound Layer

The organic compound layer has one or more of organic compound layers at least containing a light-emitting layer. Constitution of organic compound layer

Specific layer constitution includes, for example, anode/light-emitting layer/transparent cathode, anode/light-emitting layer/electron transporting layer/transparent cathode, anode/hole transporting layer/light-emitting layer/electron transporting layer/transparent cathode, anode/hole transporting layer/light-emitting layer/transparent cathode, anode/light-emitting layer/electron transporting layer/electron injecting layer/transparent cathode, anode/hole injecting layer/hole transporting layer/light-emitting layer/electron transporting layer/electron injecting layer/transparent cathode.

Light-Emitting Layer

The light-emitting layer used in the invention comprises at least one light-emitting material and may optionally contain a hole transporting material, an electron transporting material and a host material.

The light-emitting material used in the invention is not particularly restricted and any of materials can be used so long as they are fluorescent compounds or phosphorescent compounds. The fluorescent compound include various metal complexes typically represented by metal complexes or rare earth complexes of benzooxazole derivative, benzoimidazole derivatives, benzothiazole derivatives, styryl benzene derivatives, polyphenyl derivatives, diphenyl butadiene derivatives, tetraphenyl butadiene derivatives, naphthalimide derivatives, coumarin derivatives, perylene derivatives, perynone derivatives, oxadiazole derivatives, aldazine derivatives, pyraridine derivatives, cyclopentadiene derivatives, bisstyryl anthracene derivatives, quinacrydone derivatives, pyrrolo pyridine derivatives, thiadiazolopyridine derivatives, styryl amine derivatives, aromatic dimethilidene compounds, and 8-quinolinole derivatives, and polymeric compounds such as polythiophene derivatives, polyphenylene derivatives, polyphenylene vinylene derivatives, and polyfluolene derivatives. They may be used each alone or two or more of them may be used in admixture.

The phosphorescent compounds have no particular restriction and orthometallized metal complexes or porphyline metal complexes are preferred.

The orthometallized metal complexes are collective name for the group of compound described, for example, in “Organic Metal Chemistry-Foundation and Application-”, written by Akio Yamamoto, 150 p, 232 p, published from Shokabo Co. (in 1982) or “Photochemistry and Photophisics of Coordination Compounds” written by H. Yersin, pp 71 to 77, pp 135 to 146, published from Springer-Verlag Co. (in 1987), etc. The organic compound layer containing the orthometallized metal complex is advantageous in view of high luminance and excellent light emitting efficiency.

There are various ligands for forming the orthometallized metal complexes which are described also in the literatures above and preferred ligands among them include, for example, 2-phenylpyridine derivatives, 7,8-benzoquinoline derivatives, 2-(2-thienyl)pyridine derivatives, 2-(1-naphthyl)pyridine derivatives, and 2-phenylquinoline derivatives. The derivatives described above may optionally have substituents.

The orthometallized metal complex may also have other ligand in addition to the ligands described above.

The orthometallized metal complex used in the invention can be synthesized by various known methods such as Inorg. Chem., 1991, No. 30, p 1685, 1988, No. 27, p 3464, 1994, No. 33, p 545, Inorg. Chim Acta, 1991, No. 181, p 245, J. Orgsanomet. Chem., 1987, No. 335, p 293, J. Am. Chem. Soc. 1985, No. 107, p. 1431.

Among the orthometallized complexes, compounds emitting light from triplet exciton can be used suitably in the invention with a view point of improving the light emitting efficiency.

Among the porphyrin metal complexes, porphyrin platinum complexes are preferred.

The phosphorescent compounds described above may be used alone, or two or more of them may be used in combination.

Further, the fluorescent compound and the phosphorescent compound may be used together.

In the invention, use of the phosphorescent compound is preferred with the view point of the emission luminance and the light emitting efficiency.

As the hole transporting material, any of low molecular hole transporting material and high molecular hole transporting material can be used with no restriction so long as the material has a function of injecting holes from an anode, a function of transporting holes, or a function of forming barrier to electrons injected from the cathode, and includes, for example, the following materials.

They include conductive high molecular oligomers such as carbazole derivatives, triazole derivatives, oxazole derivatives, oxadiazole derivatives, imidazole derivatives, polyaryl alkane derivatives, pyrazoline derivatives, pyrazolone derivatives, phenylene diamine derivatives, arylamine derivatives, amino-substituted chalcone derivatives, styrylanthracene derivatives, fluolenone derivatives, hydrazone derivatives, stylbene derivatives, silazane derivatives, aromatic tertiary amine compounds, styrylamine compounds, aromatic dimethylidene compounds, porphyrin compounds, polysilane compounds, poly(N-vinyl carbazole) derivatives, aniline copolymers, thiophene oligomers, and polythiophene, and high molecular compounds such as polythiophene derivatives, polyphenylene derivatives, polyphenylene vinylene derivatives, and polyfluolene derivatives.

They may be used alone or two or more of them may be used in combination.

The content of the hole transporting material in the light-emitting layer is, preferably, from 0 to 99.9 mass % and more preferably from 0 to 80 mass %.

The electron transporting material has no restriction so long as the material has a function of transporting electrons or a function of forming a barrier to holes injected from the anode and can include, for example, the following materials. They include heterocyclic tetracarboxylic acid anhydrides, for example, of triazole derivatives, oxazole derivatives, oxadiazole derivatives, fluorenone derivatives, anthraquinone dimethane derivatives, anthrone derivatives, diphenylquinone derivatives, thiopyran dioxide derivatives, carbodiimide derivatives, fluorenylidene methane derivatives, distyrylpiradine derivatives, and naphthalene perylene, various kinds of metal complexes typically represented by metal complexes, for example, of phthalocyanine derivatives and 8-quinolinole derivatives and metal complexes having metal phthalocyanine, benzooxazole or benzothiazole as the ligand, conductive high molecular oligomers such as aniline copolymers, thiophene oligomers, and polythiophenes, and high molecular compounds such as polythiophene derivatives, polyphenylene derivatives, polyphenylene vinylene derivatives, and polyfluolene derivatives.

The content of the electron transporting material in the light-emitting layer is, preferably, from 0 to 99.9 mass % and more preferably, from 0 to 80 mass %.

The host compound is a compound having a function of causing energy transfer from the excited state thereof to the fluorescent compound or the phosphorescent compound and, as a result, causing the fluorescent or phosphorescent compound to emit light.

The host material has no particular restriction so long as it is a compound capable of transferring the exciton energy to the light emitting material and can be selected properly depending on the purpose. Specifically, they include heterocyclic tetracarboxylic acid anhydrides, for example, of carbazole derivatives, triazole derivatives, oxazole derivatives, oxadiazole derivatives, imidazole derivatives, polyarylalkane derivatives, pyrazoline derivatives, pyrazolone derivatives, phenylene diamine derivatives, arylamine derivatives, amino substituted chalcone derivatives, styryl anthracene derivatives, fluorenone derivatives, hydrazone derivatives, stylbene derivatives, silazane derivatives, aromatic tertiary amine compounds, styrylamine compounds, aromatic dimethylidene derivatives, porphyrin compounds, anthraquinone dimethane derivatives, anthrone derivatives, diphenylquinone derivatives, thiopyran dioxide derivatives, carbodiimide derivatives, fluorenylidene methane derivatives, distyryl pyrazine derivatives, and naphthalene perylene, various kinds of metal complexes typically represented by metal complexes of phthalocyanine derivatives and 8-quinolinole derivatives, and metal complexes having the metal phthalocyanine, benzooxazole, and benzothiazole as ligands, conductive high molecular oligomers such as polysilane compounds, poly(N-vinyl carbazole) derivatives, aniline copolymers, thiophene oligomers, and polythiophene, and polymeric compounds such as polythiophene derivatives, polyphenylene derivatives, polyphenylene vinylene derivatives, and polyfluorene derivatives.

The host compound may be used alone or two or more of them may be used in combination.

The content of the host compound in the light-emitting layer is, preferably, from 0 to 99.9 mass %, and more preferably, from 0 to 99.0 mass %.

As other ingredients, a polymer binder which is electrically inactive may be used optionally to the light emitting layer in the invention.

The electrically inactive polymer binder optionally used includes, for example, polyvinyl chloride, polycarbonate, polystyrene, polymethyl methacrylate, polybutyl methacrylate, polyester, polysulfone, polyphenylene oxide, polybutadiene, hydrocarbon resin, ketone resin, phenoxy resin, polyamide, ethyl cellulose, vinyl acetate, ABS resin, polyurethane, melamine resin, unsaturated polyester, alkyd resin, epoxy resin, silicone resin, polyvinyl butyral, and polyvinyl acetal.

In a case where the light-emitting layer contains the polymer binder, it is advantageous in that the light-emitting layer can be coated and formed easily and over a large area by a wet film forming method.

Other Organic Compound Layer

In the invention, other organic compound layers may also be disposed optionally. For example, a hole injection layer or a hole transporting layer may be disposed between the transparent electrode and the light-emitting layer, and an electron transporting layer or an electron injecting layer may also be disposed between the light emitting layer and the cathode.

The hole transporting materials described above are used for the hole transporting layer and the hole injecting layer, and the electron transporting materials are used for the electron transporting layer and the electron injecting layer suitably.

Formation of Organic Compound Layer

The organic compound layer can be formed into a film suitably by any of dry film forming method such as vapor depositing method or sputtering method, wet film forming method such as dipping method, spin coating method, dip coating method, casting method, die coating method, roll coating method, bar coating method, and gravure coating method, transferring method or printing method.

Other Layers

The other layers described above have particular restriction and can be selected properly depending on the purpose and include, for example, a protective layer.

The protective layer includes preferably those described, for example, in JP-A No. 7-85974, 7-192866, 8-22891, 10-275682, and 10-106746.

The shape, the size, the thickness, etc. of the protective layer can be selected properly, and the materials therefore, have no particular restriction so long as they have a function of suppressing intrusion or permeation of those that may deteriorate the light-emitting device such as water content or oxygen into the light-emitting device and include, for example, silicon oxide, silicon dioxide, germanium oxide, germanium dioxide, etc.

Further, in the invention, a water absorbent or an inert liquid can be disposed between a gas barrier film and a light emitting device. The water absorbent has no particular restriction and includes, for example, barium oxide, sodium oxide, potassium oxide, calcium oxide, strontium oxide, sodium sulfate, calcium sulfate, magnesium sulfate, phosphorous pentoxide, calcium chloride, magnesium chloride, copper chloride, cesium fluoride, niobium fluoride, calcium bromide, vanadium bromide, molecular sieve, zeolite, magnesium oxide, etc. The inert liquid has no particular restriction and includes, for example, paraffins, liquid paraffins, fluoro solvent such as perfluoroalkane, perfluoroamine or perfluoroether, chloro solvent, and silicone oils.

Further, an adhesive may be coated between the gas barrier film and the light-emitting device. In a case of using the layer as a filling layer, the adhesive of the filling layer can contain the water absorbent and the inert liquid described above. Further, the filling layer may also contain inorganic particles for improving the dynamic properties.

The light-emitting device of the invention can provide light emission by applying a DC voltage (optionally containing AC content) (usually from 2V to 40V) or a DC current between the anode and the cathode.

For the driving of the light-emitting device of the invention, methods described, for example, in JP-A Nos. 2-148687, 6-301355, 5-29080, 7-134558, 8-234685, and 8-241047, each of the specifications of U.S. Pat. Nos. 5,828,429 and 6,023,308, and JP-No. 2784615.

### EXAMPLE

The present invention will be further specifically explained with reference to the following examples of the present invention. The materials, amounts, ratios, types and procedures of treatments and so forth shown in the following examples can be suitably changed unless such changes depart from the gist of the present invention. Accordingly, the scope of the present invention should not be construed as limited to the following specific examples.

### Example 1

Manufacture of Gas Barrier Film Sample-A

Plastic Film Substrate

As a plastic film substrate, by biaxially stretched PEN film of 100 μm thickness (Teonex Q65) manufactured by Teijin Dupont Co.) was used. The PEN film had a glass transition temperature of 150° C. when measured in accordance with JIS-K 7122 and a light transmittance of 86.3% as measured according to JIS-K 6714.

Film Formation of First Inorganic Barrier Layer

A commercial roll-to-roll system sputtering apparatus was used. The apparatus has a vacuum vessel in which a drum for heating or cooling a plastic film substrate in contact with the surface is located at a central portion thereof. Further, a take-up roll for winding a plastic film substrate is arranged in the vacuum vessel. The plastic film substrate wound around the roll is wound by way of a guide to a drum and, further, wound around a take-up roll by way of another guide. As an evacuating system, inside of the vacuum vessel is always exhausted by a vacuum pump from an exhaustion port. A film-forming system has two cathodes connected with a DC discharge power source capable of applying a pulse power and a target metal A and a target metal B are mounted on the two cathodes A and B respectively. The discharge voltage is controlled such that the pulse power is applied alternately to the cathodes A and B. Further, the controller is connected to a piezoelectric device valve unit that supplies a reaction gas by way of a pipeline to the vacuum vessel while controlling the introduction amount. Further, the vacuum vessel is adapted such that the discharging gas at a constant flow rate is supplied. The amount of the reaction gas to be introduced is set so as to obtain a desired film thickness and the film quality and electric discharge is kept in a transition region. A method that was practiced by using the apparatus is to be described specifically.

Si was set as the target A and Al was set as the target B, and a pulse application type DC power source was provided as a discharging power source. The vacuum pump was actuated to evacuate the inside of the vacuum vessel to the order of 10⁻⁴ Pa, and argon was introduced as a discharging gas and oxygen was introduced as a reaction gas. A discharging power source was turned ON when the atmospheric pressure was stabilized to generate plasmas above each of the targets at the discharging power of 5 kW respectively, and sputtering process was started after lowering the film forming pressure to 0.03 Pa. A mixed inorganic barrier layer at SiOₓ/AlOₓ ratio of 50/50 with a thickness of 50 nm was formed on a plastic film substrate by controlling the pulse voltage and the gas flow for the target A and the target B. This was defined as sample 1A.

Film Formation of First Polymer Layer.

The sputtering apparatus used for the film formation of the first inorganic barrier layer was modified for plasma polymerizing film formation and the film formation for the first polymer layer was conducted. That is, an RF power source and electrodes were disposed instead of the DC pulse power source and the electrodes of the sputtering apparatus. An RF power source at 13.56 MHz was used for the RF power source. The discharging space was surrounded with a plasma shield to prevent redound of electric discharge to the exhaust port, etc.

Monomers gasified by evaporation under heating was introduced from a monomer tank located in the identical vacuum system into the film forming apparatus and RF power in the apparatus was turned ON to generate plasmas and monomers were radicalized to proceed polymerizing reaction.

As the monomer, hexamethyl disiloxane was used. Mass flow was controlled such that the pressure during film formation was 5×10⁻¹ Pa. The film formation was conducted while controlling the speed such that the thickness of the polymer film was 500 nm.

In order to enhance the close adhesion, oxygen was introduced instead of the monomer after the completion of the film formation in the identical apparatus to conduct oxygen plasma surface treatment. The thus prepared sample was defined as sample 2A. Film formation of second inorganic barrier layer A sample 3A was manufactured provided with the second inorganic barrier layer quite in the same method as the film formation for the first inorganic barrier layer except for using the sample 2A instead of the plastic film substrate.

Film Formation of Second Polymer Layer

A sample 4A provided with a second polymer layer was manufactured quite in the same method as that for the film formation of the first polymer layer except for using the sample 3A instead of the sample 1A.

Film Formation of Third Inorganic Barrier Layer

A sample 5A provided with a third inorganic barrier layer was manufactured quite in the same method as that for the film formation of the first inorganic barrier layer except for using the sample 4A instead of the plastic film substrate.

Film Formation of Third Polymer Layer

A sample 6A provided with a third polymer layer was manufactured quite in the same method as that for the film formation of the first polymer layer except for using the sample 5A instead of the sample 1A.

Film Formation of Fourth Inorganic Barrier Layer

A sample 7A provided with a fourth inorganic barrier layer was manufactured quite in the same method as that for the film formation of the first inorganic barrier layer except for using the sample 6A instead of the plastic film substrate.

Film Formation of Fourth Polymer Layer

A sample-A provided with a fourth polymer layer was manufactured quite in the same method as that for the film formation of the first polymer layer except for using the sample 7A instead of the sample 1A.

Manufacture of Gas Barrier Film Sample-B

The sample was manufactured quite in the same manner as in the sample-A except for changing the ratio of SiOₓ/AlOₓ to 70/30 in each of the inorganic barrier layers in the course of manufacturing the sample-A.

Manufacture of Gas Barrier Film Sample-C

The sample was manufactured quite in the same manner as in the sample-A except for changing the ratio of SiOₓ/AlOₓ to 20/80 in each of the inorganic barrier layers in the course of manufacturing the sample-A.

Manufacture of Gas Barrier Film Sample-D

The sample was manufactured quite in the same manner as in the sample-A excepting that the both of the two targets were Si in the film formation for each of the inorganic barrier layers in the course of manufacturing the sample-A.

Manufacture of Gas Barrier Film Sample-E

The sample was manufactured quite in the same manner as in the sample-A excepting that the both of the two targets were Al in the film formation for each of the inorganic barrier layers in the course of manufacturing the sample-A.

Manufacture of Gas Barrier Film Sample-1F

Flaky starting materials of SiO₂ and Al₂O₃ were used as the vapor depositing material and they were vapor deposited on a biaxially stretched PEN film substrate at Si/Al ratio of 35/65 by using an electron beam vapor deposition method. The thickness of the inorganic barrier layer was 50 nm.

Manufacture of Gas Barrier Film Sample-G

A sample was manufactured in the same manner as in Sample-A except for changing the film formation for each of the polymer layers to that by the poly-addition reaction method in the course of the manufacturing the sample-A. Polyaddition method

4,4′-diphenylmethane diisocyanate and 4,4∝-diamino diphenylmethane were used as two evaporation sources and they were evaporated under heating at 170° C. for the former and at 140° C. for the latter. The two kinds of vapors were introduced into a mixing chamber heated at 100° C., mixed and then sent through a perforated above the plastic film substrate controlled to 40° C., the polymerizing reaction was proceeded on the surface of the substrate to conduct film formation.

Evaluation for Gas Barrier Property

The evaluation for the barrier property of each sample was conducted by calcium corrosion method. The calcium corrosion method was in accordance with the method of G. Ni Sato (2001 IDW Conference Proceedings). That is, a thin metal calcium film was prepared by a vapor deposition method on a gas barrier film sample, which was instantly sealed with a glass plate and an epoxy adhesive XNR-5516-HV (Nagase ChemteX Corp.) to manufacture a test cell. The test cell was stored at each levels of temperature at a relative humidity of 90%, and the corrosion amount of calcium was determined based on the change of the light transmittance, which was converted into a value of water vapor transmittance ratio (WVTR) at 38° C.

Further, a repetitive bending test was conducted at 25° C. for the gas barrier films. The bending test was conducted at IPC bending test according to IPC standard TM-650. In the test, the film was put between a fixed plate and a moveable plate in a bent state with a barrier surface being convexed and the moveable plate is moved repetitively. A film was set to 10 mmR and 60 mm stroke and test was conducted for the repetitive cycles of 50 times and 500 times.

Then, also for the gas barrier film conducted for the repetitive bending test, a calcium test cell was manufactured in the same manner as that before conducting bending test and WVTR evaluation was conducted in the same manner by the preservation test.

The results are shown collectively in Table 1.

TABLE 1

| | WVTR | WVTR after | WVTR after | |
|---|---|---|---|---|
| | before | bending for 50 | bending for | |
| Sample | bending | cycles | 500cycles | |
| name | (g/m²/day) | (g/m²/day) | (g/m²/day) | Remarks |
| 2A | 0.30 | 0.35 | 0.30 | Comparative |
| | | | | Example |
| 4A | 0.004 | 0.003 | 0.004 | Invention |
| 6A | 7 × 10⁻⁵ | 6 × 10⁻⁵ | 7 × 10⁻⁵ | Invention |
| -A | 3 × 10⁻⁶ | 4 × 10⁻⁶ | 4 × 10⁻⁶ | Invention |
| -B | 4 × 10⁻⁶ | 5 × 10⁻⁶ | 5 × 10⁻⁶ | Invention |
| -C | 6 × 10⁻⁶ | 8 × 10⁻⁶ | 9 × 10⁻⁶ | Invention |
| -D | 0.006 | 0.005 | 0.006 | Comparative |
| | | | | Example |
| -E | 5 × 10⁻⁵ | 0.03 | 12 | Comparative |
| | | | | Example |
| 1F | 0.45 | 0.75 | 15 | Comparative |
| | | | | Example |
| -G | 2 × 10⁻⁶ | 3 × 10⁻⁶ | 3 × 10⁻⁶ | Invention |

From the result of Table 1, it has been found that the gas barrier film in which the inorganic barrier layer consists only of SiOₓ (-D) is insufficient for the steam barrier property even when laminated as multi-layers and, on the other hand, a gas barrier film in which the inorganic barrier layer consists only of AlOₓ (-E) shows comparatively favorable barrier property in a case with no bending but it remarkably deteriorates by the repetitive bending test.

A gas barrier film assumed for foodstuff use in which SiO₂ and Al₂O₃ are co-vapor deposited (1F) was quite insufficient both for the steam barrier property and repetitive bending resistance.

On the other hand, it has been found that the gas barrier film of the invention in which the inorganic barrier layer comprises a mixed film of SiOₓ/AlOₓ has high steam barrier property before the bending test and keeps the high barrier property also after the repetitive bending test.

### Example 2

Manufacture of Organic EL Device I of the Invention

An anode comprising an indium tin oxide (ITO, indium/tin=95/5 molar ratio) was formed (0.2 μm thickness) by sputtering on a gas barrier film sample-A substrate of the invention cut into 25 mm×25 mm×0.5 mm by using a DC power source. Copper phthalocyanine (CuPc) was formed to 10 nm on the anode as a hole injecting layer by vacuum vapor deposition, on which N,N′-dinaphtyl-N,N′-diphenyl benzidine was formed by 40 nm by vacuum vapor deposition as a hole transporting layer. 4,4′-N,N′-dicarbazole biphenyl as the host material, bis[(4,6-difluorophenyl)-pyridinate-N,C2′](picolinate) iridium complex (Firpic) as a blue light-emitting material, tris(2-phenylpiridine)iridium complex (Ir(ppy)3) as a green light-emitting material, and bis(2-phenylquinoline) acetylacetonate iridium as a red-light-emitting material were co-vapor deposited each at 100/2/4/2 mass ratio thereon to obtain a light-emitting layer of 40 nm. 2,2′,2′″-(1,3,5-benzene triyl)tris[3-(2-methylphenyl)-3H-imidazo[4,5-b]pyridine] as an electron transporting material was vapor deposited further thereon at a rate of 1 nm/sec to form an electron transporting layer of 24 nm thickness. A patterned mask (a mask providing a light-emitting area of 5 mm×5 mm) was stacked over the organic compound layer, lithium fluoride was vapor deposited to 1 nm in the vapor deposition apparatus and, further, aluminum was vapor deposited to 100 nm to form a cathode. Further, a ceramic sheet (heat irradiation rate; 0.96, sheet thickness: 300 μm) was bonded on the side opposite to the aluminum cathode surface having the organic compound layer. Aluminum lead wires were attached respectively from the anode and the cathode to prepare a light-emitting device. In order not to contact the organic El layer with external air, the device was sealed with another gas barrier film sample-A of the invention. The organic El device I of the invention was obtained by the method described above.

Manufacture of Organic EL Device II of the Invention

An organic EL device II of the invention was manufactured in the same manner as the organic EL device I except for using a gas barrier sample-G instead of the gas barrier sample A as the substrate and the sealing film in the manufacture of the organic EL device I described above. Manufacture of organic EL device III for comparative use

An organic EL device III of the invention was manufactured in the same manner as the organic EL device I except for using a gas barrier sample-1F instead of the gas barrier sample-A as the substrate and the sealing film in the manufacture of the organic EL device I described above. Preservation test

For the thus obtained organic EL devices I to III, a preservation test for 1000 hours at 60° C. and 90% relative humidity was conducted to determine the residual light emission illuminance after the preservation test relative to the light emitting illuminance before the preservation test. The results are shown in Table 2.

TABLE 2

| | | Residual light | |
|---|---|---|---|
| Organic El | Gas barrier | emission | |
| device | film | illuminance (%) | Remark |
| I | -A | 80 | Invention |
| II | -G | 95 | Invention |
| III | 1F | 0 (with no light | Comparative |
| | | emission) | Example |

In the organic EL device III using the gas barrier film sample 1F in which only the inorganic barrier layer was formed on the plastic film substrate, the light emission was reduced to 0 after several hours. On the contrary, in the organic EL devices I and II using the gas barrier film of the invention, light emission was maintained also with no remarkable shrinkage for picture elements. In the organic EL device I using the gas barrier film sample-A in which the polymer film was made of an acrylate polymer, dark spots were observed here and there after 500 hours and corresponding lowering of the emission illuminance was observed. However, in the organic EL device II using the gas barrier film sample-G in which a polymer film was formed by the poly addition polymerizing method, occurrence of dark spots were not observed and the illuminance was scarcely lowered.

Since the gas barrier film according to the invention has extremely high gas barrier property, it can be used in various fields. Further, the organic device, particularly, an organic EL device of the invention manufactured by using the gas barrier film is flexible and has long life. Accordingly, the invention is applicable generally in the manufacture and the use of organic devices.

The present disclosure relates to the subject matter contained in Japanese Patent Application No. 109356/2005 filed on Apr. 6, 2005, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A gas barrier film comprising, on a plastic film substrate, at least one two-layer unit consisting of an inorganic barrier layer and a polymer layer adjacent to the inorganic barrier layer, in which at least one of the inorganic barrier layers in the gas barrier film comprises two or more kinds of metal oxides, and the steam permeability of the gas barrier film at 38° C. and 90% relative humidity is 0.005 g/m²/day or less.

2. A gas barrier film according to claim 1, comprising at least one gas barrier lamination member in which a two-layer unit consisting of an inorganic barrier layer comprising two or more kinds of metal oxides and a polymer layer adjacent to the inorganic barrier layer is laminated repetitively by 3 to 5 times.

3. A gas barrier film according to claim 1, wherein the two or more kinds of metal oxides contain aluminum oxide and silicon oxide.

4. A gas barrier film according to claim 1, wherein the inorganic barrier layer comprising two or more kinds of metal oxides is formed by a reactive sputtering method with plasma in which a plurality of metal targets and an oxygen gas are used as starting materials.

5. A gas barrier film according to claim 1, wherein the inorganic barrier layer comprising two or more kinds of metal oxides is formed by a vapor deposition method under electron beam heating in which a plurality of metals or metal oxides are used as an evaporation source.

6. A gas barrier film according to claim 1, wherein a polymer constituting the plastic film substrate has a glass transition temperature of 120° C. or higher and a light transmittance in the entire wavelength region of from 400 nm to 700 nm of 85% or higher.

7. A gas barrier film according to claim 1, wherein the polymer layer contains a polysiloxane formed by a plasma polymerization method.

8. A gas barrier film according to claim 1, wherein the polymer layer contains a polyparaxylylene formed by a vapor deposition polymerization method.

9. A gas barrier film according to claim 1, wherein the polymer layer contains a polymer formed by a polyaddition reaction in which two kinds of monomers are evaporated in vacuum.

10. A gas barrier film according to claim 1, wherein the polymer layer is formed by forming a thin film of an acrylic polymer by a flash vapor deposition method and then curing the same by using UV-rays or electron beams.

11. A gas barrier film according to claim 1, wherein the polymer layer is formed by forming a thin film of a photocationic curable polymer by a flash vapor deposition method and then curing the same by using UV-rays or electron beams.

12. An organic device manufactured by using the gas barrier film according to claim 1.
